(19) United States
(12) Patent Application Publication
(10) Pub. No.: US 2025/0187258 A1
(43) Pub. Date: Jun. 12, 2025

(54) CONDUCTOR-INTEGRATED RESIN PART AND MANUFACTURING METHOD THEREOF

(71) Applicant: Yazaki Corporation, Tokyo (JP)

(72) Inventors: Kenichi IMOU, Shizuoka (JP); Taku FURUTA, Shizuoka (JP); Shuji KIMURA, Shizuoka (JP)

(73) Assignee: Yazaki Corporation, Tokyo (JP)

(21) Appl. No.: 18/966,388

(22) Filed: Dec. 3, 2024

(30) Foreign Application Priority Data
Dec. 6, 2023 (JP) 2023-205961

(51) Int. Cl. B29C 64/10; B29C 64/386; B29L 31/36; B33Y 50/00; B33Y 80/00

(52) U.S. Cl. CPC B29C 64/10; B29C 64/386; B29L 2031/36; B33Y 50/00; B33Y 80/00

(57) ABSTRACT

The conductor-integrated resin part includes a wiring material that is electroconductive, and a resin part for holding the wiring material. The wiring material and the resin part are formed by laminating in a plurality of layers, and the wiring material is made of at least one of a copper alloy or an electroconductive resin.

### CROSS-REFERENCE TO RELATED APPLICATIONS

The present application is based on, and claims priority from the prior Japanese Patent Application No. 2023-205961, filed on Dec. 6, 2023, the entire contents of which are incorporated herein by reference.

### TECHNICAL FIELD

The present disclosure relates to a conductor-integrated resin part and a manufacturing method thereof.

### BACKGROUND

JP2014-135168 A discloses a technology related to a conductor-integrated resin part and a manufacturing method thereof. Conventionally, among automotive parts, resin molded parts having conductors are mainly manufactured in two methods. One method includes preparing a wire harness with bundled electroconductive electric wires and a protective material or the like attached for protection from external damage, and combining it with a resin molded part.

The other method includes punching a copper plate into a circuit pattern, and molding a resin around it. Such a resin molded part is called a molded bus bar. JP2014-135168 A discloses a method of manufacturing a molded bus bar, in which a bus bar, which is an electroconductive plate, is held in a mold and a resin molded part, which is an insulator, is formed between the bus bars.

### SUMMARY OF THE INVENTION

However, in a method of manufacturing a conductor-integrated resin part as disclosed in JP2014-135168 A, manufacturing facilities are required for each of manufacturing a wiring material, manufacturing a resin part, and integrating the wiring material and the resin part. Therefore, a large amount of time and cost are required for product design, and the manufacturing process is complicated and inefficient.

The present disclosure has been made in view of such problems of the conventional technology. It is an object of the present disclosure to provide a conductor-integrated resin part and a method of manufacturing thereof, in which a wiring material and a resin part are manufactured in the same process, thereby improving manufacturing efficiency.

A conductor-integrated resin part according to an aspect of the present embodiment includes a wiring material that is electroconductive, and a resin part for holding the wiring material, in which the wiring material and the resin part are formed by laminating in a plurality of layers, and the wiring material is made of at least one of a copper alloy or an electroconductive resin.

A method of manufacturing a conductor-integrated resin part according to an aspect of the present embodiment includes a design data generation process for generating design data for outputting at least one of a 3D printer copper alloy or a 3D printer electroconductive resin constituting a wiring material, and a 3D printer resin constituting a resin part, from a 3D printer, and a 3D printer outputting process for forming a wiring material and a resin part by laminating in a plurality of layers by ejecting at least one of the 3D printer copper alloy or the 3D printer electroconductive resin constituting the wiring material, and the 3D printer resin constituting a resin part, from a 3D printer head, based on the design data generated in the design data generation process.

According to the present disclosure, it is possible to provide a conductor-integrated resin part and a manufacturing method thereof, in which a wiring material and a resin part are manufactured in the same process, thereby improving the manufacturing efficiency.

### BRIEF DESCRIPTION OF DRAWINGS

FIG. 1 is a schematic view illustrating a method of manufacturing a conductor-integrated resin part according to the present embodiment and a process of generating design data.

FIG. 2 is a schematic view illustrating a method of manufacturing a conductor-integrated resin part according to the present embodiment and a process of 3D printer output.

FIG. 3 is a perspective view illustrating a completed state of a conductor-integrated resin part according to the present embodiment.

### DETAILED DESCRIPTION OF THE INVENTION

Hereinafter, a conductor-integrated resin part according to the present embodiment and a method of manufacturing thereof will be described in detail with reference to the drawings. The dimensional ratios in the drawings are exaggerated for convenience of explanation and may differ from the actual ratios.

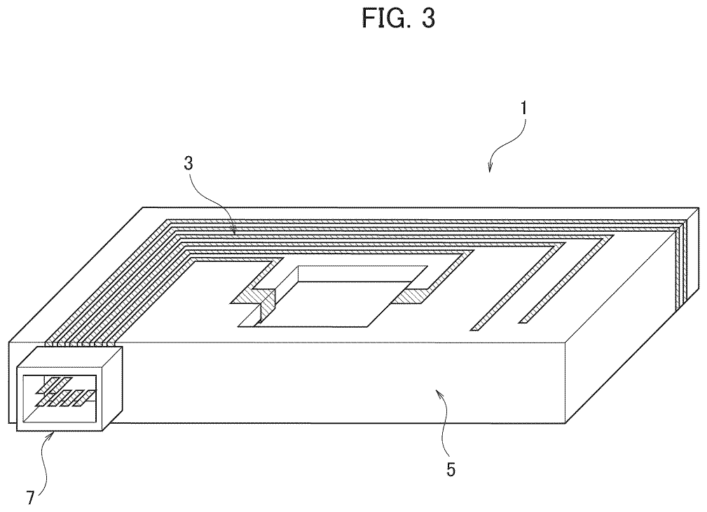

As shown in FIG. 3, a conductor-integrated resin part 1 according to the present embodiment includes a wiring material 3 that is electroconductive, and a resin part 5 for holding the wiring material 3. The wiring material 3 and the resin part 5 are formed by laminating in a plurality of layers.

The wiring material 3 and the resin part 5 may be formed by laminating in a plurality of layers using a 3D printer. A 3D printer is a device for forming a three-dimensional object by sequentially laminating molding materials, based on three-dimensional molding data generated by a computer.

The wiring material 3 has conductivity, and is made of at least one of a copper alloy or an electroconductive resin. The copper alloy constituting the wiring material 3 may be a 3D printer copper alloy, and the electroconductive resin constituting the wiring material 3 may be a 3D printer electroconductive resin. The resin part 5 may be made of a 3D printer resin. In the case that the material constituting the wiring material 3 or the resin part 5 is a material usable for 3D printers, usable materials are not particularly limited, but differ depending on the molding method of the 3D printer as described below.

As the copper alloy, for example, those specified in the Japanese Industrial Standard JIS H3100 (Copper and copper alloy sheets, plates and strips) may be used. Specifically, oxygen-free copper (C1020), tough pitch copper (C1100), phosphorus-deoxidized copper (C1201), tin-containing copper (C1441), zirconium-containing copper (C1510), iron-containing copper (C1921), or the like can be used.

The copper alloy may further include metals and compounds other than copper alloys. The metals and compounds other than copper and copper alloys include, for example, one or more elements selected from the group consisting of Ni, Co, Fe, Pt, Au, Al, Si, Cr, Mg, Mn, Mo, Rh, Ta, Ti, W, U, V, and Zr, or compounds containing the one or more elements.

The electroconductive resin may contain at least one of metal or carbon. Further, a resin in which at least one of metal or carbon is contained in the resin constituting the resin part 5 may be used.

The metal used for the electroconductive resin is made of, for example, one or more elements selected from the group consisting of Cu, Ni, Co, Fe, Pt, Au, Al, Si, Cr, Mg, Mn, Mo, Rh, Ta, Ti, W, U, V, and Zr, or compounds containing the one or more elements.

The carbon used for the electroconductive resin includes, for example, at least one material selected from the group consisting of carbon black, carbon fiber, CNT (carbon nanotube), and diamond.

If the resin constituting the resin part 5 is a 3D printer resin, the material that can be used differs depending on the molding method of the 3D printer as described below. Therefore, a thermoplastic resin, a photocurable resin, or the like suitable for the molding method of each 3D printer can be used.

Examples of the molding method of the 3D printer include, for example, a fused deposition modeling (FDM), a material jetting method, a binder jetting method, a powder bed fusion method (SLS method, SLM method, EBM method), a stereolithography (SLA method and DLP method), and the like.

The fused deposition modeling is a method in which a thermoplastic resin melted at a high temperature is ejected from the 3D printer head, and is laminated layer by layer. Therefore, the 3D printer resin constituting the resin part 5 may include known thermoplastic resins, and at least one selected from the group consisting of a polyacetal resin, polyethylene resin, polypropylene resin, polyethylene terephthalate (PET) resin, polybutylene terephthalate (PBT) resin, polyamide resin, acrylonitrile-butadiene-styrene copolymer (ABS) resin, polycarbonate (PC) resin, PC/ABS resin, and polylactic acid (PLA) resin may be used. The material used in the fused deposition modeling may be a synthetic material obtained by mixing other materials with the thermoplastic resin. Therefore, it is also possible to produce a 3D printer electroconductive resin constituting the wiring material 3 by mixing an electroconductive material such as metal or carbon with the thermoplastic resin.

In the material jetting method, a liquid photocurable resin or the like is ejected from a 3D printer head, and then cured and laminated layer by layer by irradiating with ultraviolet light. Therefore, the 3D printer resin constituting the resin part 5 may include known photocurable resins, and at least one of an acrylic resin or an epoxy resin may be used. It is also possible to produce a 3D printer electroconductive resin constituting the wiring material 3 by mixing a electroconductive material such as metal or carbon with a photocurable resin which is a material used in the material jetting method.

In the binder jet method, a resin and a metal powders are ejected from the 3D printer head, on which a photocurable resin is further ejected as a binder from the 3D printer head, and the powders are solidified and laminated layer by layer. Therefore, the 3D printer resin constituting the resin part 5 may include known photocurable resins, and at least one of an acrylic resin or an epoxy resin may be used. In the binder jetting method, a photocurable resin may be ejecting as a binder to an electroconductive material such as metal or carbon, and it is also possible to produce a 3D printer copper alloy or a 3D printer electroconductive resin constituting the wiring material 3.

In the powder bed fusion method, a powdery material ejected from a 3D printer head is irradiated with a laser beam or an electron beam to be sintered or melted, and laminated. Furthermore, the powder bed fusion method is classified into the SLS method for sintering with a laser beam, the SLM method for melting with a laser beam, and the EBM method for melting with an electron beam. Therefore, the 3D printer resin constituting the resin part 5 includes a powdery resin used in the SLS method, and at least one selected from the group consisting of a nylon resin, a polypropylene resin, a polystyrene resin, and a thermoplastic elastomer may be used. Among the powder bed fusion methods, the SLM method or the EBM method is also useful as a molding method for melting and solidifying metal, and it is also possible to produce a 3D printer copper alloy constituting the wiring material 3 by these methods.

The stereolithography is a method in which a liquid photocurable resin is cured, and laminated layer by layer. The stereolithography is further classified into the SLA in which a resin is cured while irradiating with an ultraviolet laser, the DLP method in which a resin is cured while irradiating with an LED beam, or the like. The 3D printer resin constituting the resin part 5 may include known photocurable resins, and at least one of an acrylic resin or an epoxy resin may be used. It is also possible to produce the 3D printer electroconductive resin constituting the wiring material 3 by mixing an electroconductive material such as metal or carbon with the photocurable resin used in the stereolithography.

The wiring material 3 has conductivity and is made of at least one of a copper alloy or an electroconductive resin. As described above, it is possible to produce a copper alloy or an electroconductive resin constituting the wiring material 3 by mixing an electroconductive material such as metal or carbon with a thermoplastic resin or a photocurable resin, or by directly melting the metal. That is, the wiring material 3 may be formed by solidifying a fluid metal-containing material.

As described above, the wiring material and the resin part for the conductor-integrated resin part in the present embodiment can be manufactured by using a 3D printer in the same process in the same workspace of one manufacturing facility. That is, the wiring material and the resin part can be manufactured in the same process to provide a conductor-integrated resin part with improved manufacturing efficiency.

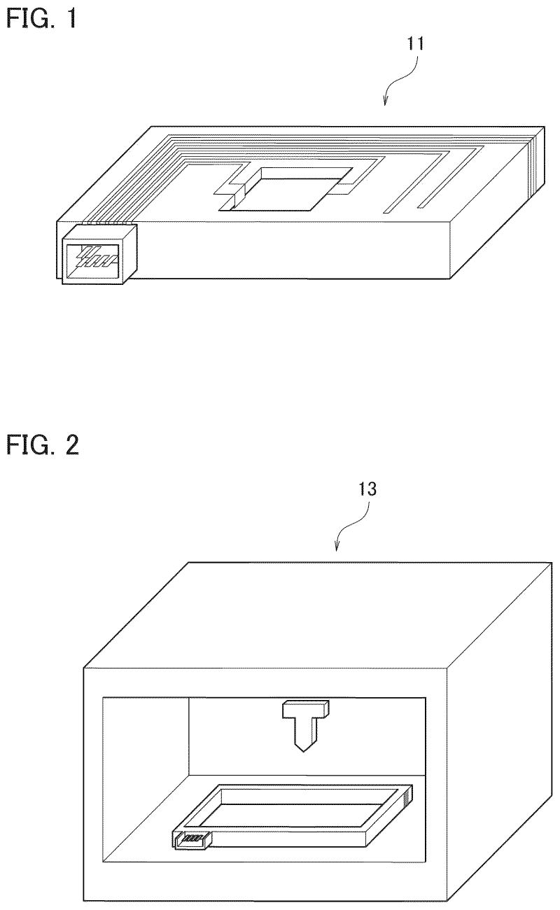

The manufacturing method of the electroconductive resin part in the present embodiment includes a design data generation process illustrated in FIG. 1, and a 3D printer output process illustrated in FIG. 2.

The design data generation process is a process of generating design data 11 for outputting at least one of a 3D printer copper alloy or a 3D printer electroconductive resin constituting a wiring material 3 and a 3D printer resin constituting a resin part 5, from the 3D printer 13. More specifically, the design data 11 is first generated, and then the design data thinly sliced for 3D printer output is generated.

The 3D printer outputting process is a process of forming the wiring material 3 and the resin part 5 by laminating in a plurality of layers by ejecting the above-mentioned materials constituting the wiring material 3 and the above-mentioned materials constituting the resin part 5 from the 3D printer head based on the design data 11 generated in the design data generation process. Specifically, there is a 3D printer head for each of the materials of the wiring material 3 and the resin part 5, and the materials charged into the 3D printer head are ejected, output in the workspace layer by layer, and laminated as illustrated in FIG. 2.

Finally, as illustrated in FIG. 3, the conductor-integrated resin part 1 is completed. The use of conductor-integrated resin part 1 is not particularly limited, but it can be used as a resin molded component having a conductor in an automotive component. As illustrated in FIG. 3, the conductor-integrated resin part 1 may include a terminal 7 connected to a mating terminal (not illustrated). In this way, it is possible to provide a method of manufacturing a conductor-integrated resin part in which a wiring material and a resin part are manufactured in the same process by using a 3D printer to improve manufacturing efficiency.

In the conventional method of manufacturing a conductor-integrated resin part, manufacturing facilities are required for each of manufacturing a wiring material, manufacturing a resin part, and integrating the wiring material and the resin part. Therefore, a large amount of time and cost are required for product design, and the manufacturing process is complicated. In particular, low-volume products have a problem that, if they are manufactured by the same manufacturing method as mass production, the depreciation cost of the manufacturing facilities becomes high, and the cost of the products eventually rises. In the future automobile industry, it is assumed that addition of new equipment or order of manufacturer options after the purchase of vehicles will expand, and it is expected that the number of products manufactured in small quantities, such as a few units per month, increases. In the method of manufacturing the conductor-integrated resin part in this embodiment, the wiring material and the resin part are manufactured in the same process, so that the preparation time for design and development and the design of the manufacturing line can be shortened, and the increase in the cost of the products can be suppressed even in low-volume production.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A conductor-integrated resin part comprising:
a wiring material that is electroconductive; and
a resin part for holding the wiring material;
wherein the wiring material and the resin part are formed by laminating in a plurality of layers, and
the wiring material is made of at least one of a copper alloy or an electroconductive resin.

2. The conductor-integrated resin part according to claim 1, wherein
the copper alloy is a 3D printer copper alloy and the electroconductive resin is a 3D printer electroconductive resin, and
the resin part is made of a 3D printer resin.

3. The conductor-integrated resin part according to claim 1, wherein the electroconductive resin contains at least one of metal or carbon.

4. A method of manufacturing a conductor-integrated resin part according to claim 2, comprising:
a design data generation process for generating design data for outputting at least one of a 3D printer copper alloy or a 3D printer electroconductive resin constituting a wiring material, and a 3D printer resin constituting a resin part, from a 3D printer, and
a 3D printer outputting process for forming the wiring material and the resin part by laminating in a plurality of layers by ejecting at least one of the 3D printer copper alloy or a 3D printer electroconductive resin constituting the wiring material, and a 3D printer resin constituting the resin part, from a 3D printer head, based on the design data generated in the design data generation process.
